(19) United States
(12) Patent Application Publication
(10) Pub. No.: US 2025/0180717 A1
(43) Pub. Date: Jun. 5, 2025

(54) SENSOR ASSEMBLY WITH MOVABLE COVER

(71) Applicant: GM GLOBAL TECHNOLOGY OPERATIONS LLC, Detroit, MI (US)

(72) Inventors: Kothamasi Sumithra Raju, Bangalore (IN); Sudipto Ray, Banglore (IN); Yuchuan Liu, Troy, MI (US); Julien P. Mourou, Bloomfield Hills, MI (US)

(73) Assignee: GM GLOBAL TECHNOLOGY OPERATIONS LLC, Detroit, MI (US)

(21) Appl. No.: 18/525,982

(22) Filed: Dec. 1, 2023

(51) Int. Cl. G01S 7/497

(52) U.S. Cl. CPC G01S 7/497; G01S 2007/4977

(57) ABSTRACT

A sensor assembly includes a sensor and a sensor cover positioned adjacent to the sensor and within a field of view of the sensor. The sensor cover includes an interior surface facing the sensor and an exterior surface facing away from the sensor. Spring elements are attached to the sensor cover at a first end and a mount at a second end. At least one of the spring elements includes a first spring stiffness and another one of the spring elements includes a second spring stiffness. A drive motor is in mechanical connection with the mount and configured to rotate the sensor cover relative to the sensor.

### INTRODUCTION

The present disclosure generally relates to sensors and, more particularly, to a sensor assembly with a moveable cover for cameras, sensors, lidar, and the like.

Some vehicles include sensors to detect and/or measure different parameters. The sensors may include covers that should be cleaned to keep the sensors working optimally. Specifically, various contaminants (e.g., dust, water, snow) should be removed from the cover of the sensor. The covers of the sensors may also have hydrophilic or hydrophobic coatings for keeping the covers clean.

### SUMMARY

Disclosed here is a sensor assembly. The sensor assembly includes a sensor and a sensor cover positioned adjacent to the sensor and within a field of view of the sensor. The sensor cover includes an interior surface facing the sensor and an exterior surface facing away from the sensor. Spring elements are attached to the sensor cover at a first end and a mount at a second end. At least one of the spring elements includes a first spring stiffness and another one of the spring elements includes a second spring stiffness. A drive motor is in mechanical connection with the mount and configured to rotate the sensor cover relative to the sensor.

Another aspect of the disclosure may be where the plurality of spring elements is positioned around a perimeter of the sensor cover.

Another aspect of the disclosure may be where the drive motor is a piezo-electric drive motor.

Another aspect of the disclosure may be where the plurality of spring elements includes at least one coil spring.

Another aspect of the disclosure may be where the sensor includes an optical sensor having a lens.

Another aspect of the disclosure may be where the sensor cover is comprised of a transparent material.

Another aspect of the disclosure may be where the mount forms a ring.

Another aspect of the disclosure may be where the plurality of spring elements includes a first pair of spring elements located along a first pair of opposing sides of the sensor cover and a second pair of spring elements having a second located along a second pair of opposing sides of the sensor cover.

Another aspect of the disclosure may be where the first pair of spring elements each include a first stiffness and the second pair of spring elements each include a second stiffness that is less than the first stiffness.

Another aspect of the disclosure may be where the first pair of spring elements include a first pair of different spring stiffnesses and the second pair of spring elements includes a second pair of different spring stiffnesses that are each less than the first pair of different spring stiffnesses.

Another aspect of the disclosure may be where the first pair of spring elements include a spring stiffness of greater than or equal to 3000 N/m and less than or equal to 6000 N/m.

Another aspect of the disclosure may be where the second pair of spring elements include a spring stiffness of greater than or equal to 30 N/m and less than or equal to 300 N/m.

Disclosed herein is a cleaning assembly for a sensor. The assembly includes a sensor housing, a sensor located within the sensor housing, and a sensor cover positioned adjacent to the sensor and within a field of view of the sensor. The sensor cover includes an interior surface facing the sensor and an exterior surface facing away from the sensor. Spring elements are attached to the sensor cover at a first end and a mount at a second end. At least one of the spring elements includes a first spring stiffness and another one of the spring elements includes a second spring stiffness. A drive motor is in mechanical connection with the mount and configured to rotate the sensor cover relative to the sensor. A controller in electrical communication with the drive motor to operate the drive motor under a first operating condition.

Disclosed herein is a vehicle. The vehicle includes a passenger compartment, wheels supporting the passenger compartment, and a sensor assembly fixed relative to the passenger compartment. The sensor assembly includes a sensor and a sensor cover positioned adjacent to the sensor and within a field of view of the sensor. The sensor cover includes an interior surface facing the sensor and an exterior surface facing away from the sensor. Spring elements are attached to the sensor cover at a first end and a mount at a second end. At least one of the spring elements includes a first spring stiffness and another one of the spring elements includes a second spring stiffness. A drive motor is in mechanical connection with the mount and configured to rotate the sensor cover relative to the sensor.

### DESCRIPTION OF THE DRAWINGS

FIG. 1 is a schematic diagram of a vehicle including a plurality of sensor assemblies.

FIG. 2 is a schematic side view of a sensor with a sensor cover assembly in one of the plurality of sensor assemblies of FIG. 1 with a sensor cover in a first position.

FIG. 3 is a schematic side view of the sensor with the sensor cover in a second position.

FIG. 4 is a perspective view of the sensor cover assembly.

Some embodiments of the present disclosure are now described, by way of example only, and with reference to the accompanying drawings. The same reference number represents the same element or the same type of element on the drawings.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

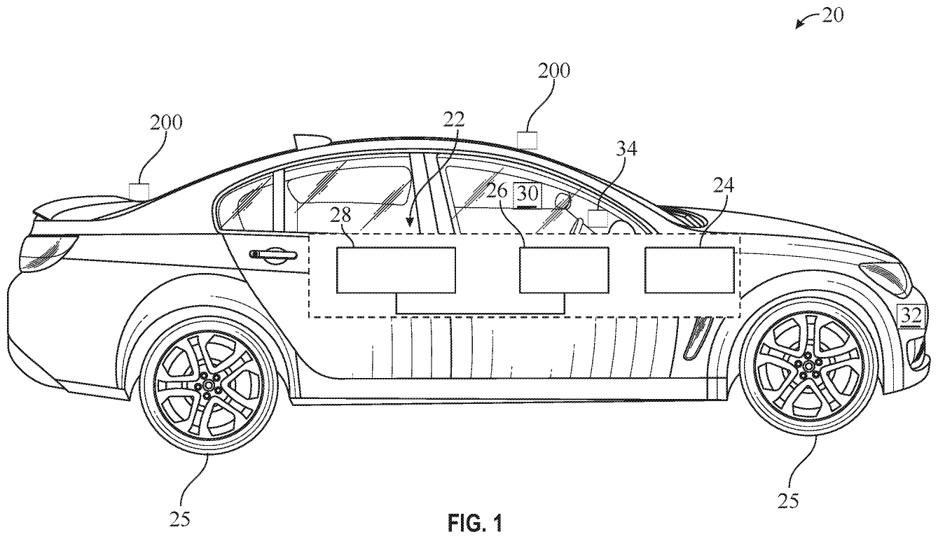

In accordance with an exemplary embodiment, FIG. 1 shows a vehicle 20 that can be operated in an autonomous mode or automated mode. The vehicle 20 can be a fully autonomous vehicle or a semi-autonomous vehicle. The vehicle 20 includes a body defining a passenger compartment supported by wheels 25 and a driving system 22 that controls autonomous operation of the vehicle 20. The driving system 22 includes a sensor system 24 for obtaining information about the surrounding or environment of the vehicle 20, and a controller 26 for computing possible actions for the autonomous vehicle based on the obtained information and for implementing one or more of the possible actions, and a human machine interface 28 for communicating with an occupant of the vehicle, such as a driver or passenger. The sensor system 24 can include at least one optical sensor 30, such as at least one camera, at least one distance sensor 32, such as a depth camera (RGB-D) or Lidar, and an eye-gaze monitoring system 34. In the illustrated example, the optical sensor 30 and the distance sensor 32 include at least partially overlapping fields of view in order to relate information captured by each of the sensors.

The controller 26 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 26 may include a non-transitory computer-readable medium that stores instructions which, when processed by one or more processors of the controller 26, implement a method of operating a sensor assembly with a movable cover, according to one or more embodiments detailed herein.

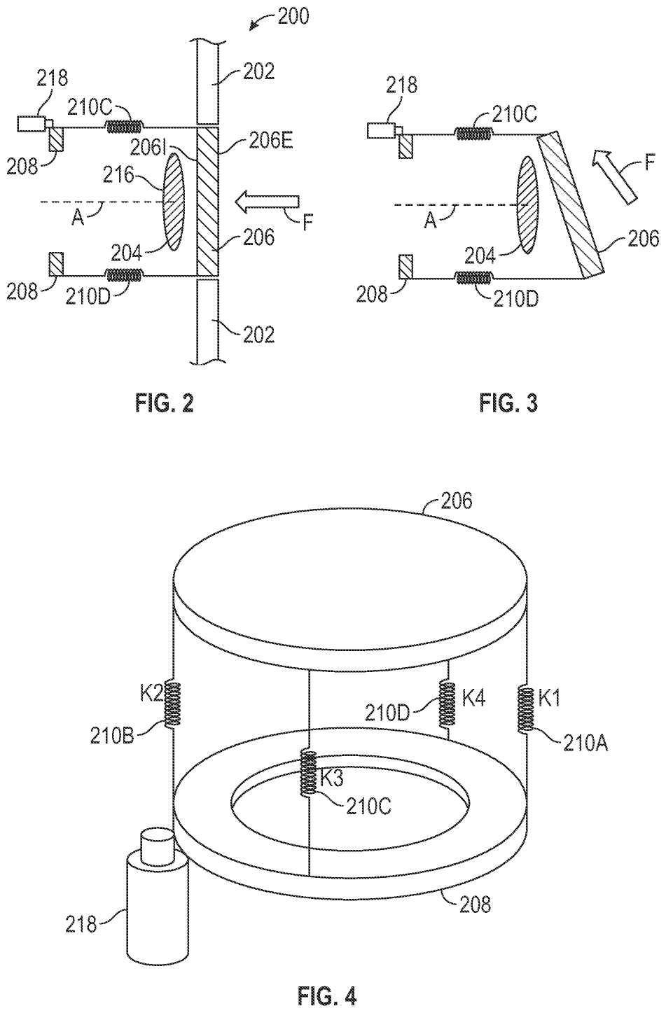

FIG. 2 schematically illustrates a side view of one of the sensor assemblies 200, such as an assembly for cleaning a sensor. The sensor assembly 200 includes a sensor housing 202 for enclosing one or more sensors 204. The sensor housing 202 can be fixed relative to the vehicle 20 in multiple different locations, such as adjacent a front or rear portion of the vehicle 20. A sensor cover 206 allows for the sensor 204 to have a field of view outside of the sensor housing 202. For example, the sensor cover 206 could be cylindrical and made of a transparent material that allows the sensor 204 to have a field of view outside of the sensor housing 202. The sensor cover 206 is supported relative to a rotatable mount 208, such as a ring, by multiple spring elements 210, such as the spring elements 210A, 210B, 210C, and 210D. In the illustrated example, the sensor cover 206 is supported by four separate spring elements 210A, 210B, 210C, and 210D (FIG. 4), such as coil springs. However, other types of spring elements, such as elastomeric based spring elements could be used instead of the coil springs. Additionally, fewer than four spring elements 210 or more than four spring elements, such as six spring elements 210 could be used to support the sensor cover 206 relative to the mount 208.

In the illustrated example, the spring elements 210A, 210B, 210C, 210D include spring stiffnesses K1, K2, K3, and K4, respectively. In one example, the spring stiffnesses K1 and K2 are each greater than the spring stiffnesses K3 and K4. Furthermore, the spring stiffnesses K1 and K2 for the spring elements 210A and 210B, respectively, can be equal to each other. Similarly, the spring stiffnesses K3 and K4 for the spring elements 210C and 210D can be equal to each other. Alternatively, the spring stiffnesses K1 and K2 can vary relative to each other and the spring stiffnesses K3 and K4 can vary relative to each other with the spring stiffnesses K3 and K4 both being less than the spring stiffnesses K1 or K2, respectively. In one example the spring stiffnesses K1 and K2 are greater than or equal to 3000 N/m and less than or equal to 6000 N/m and the spring stiffnesses K3 and K4 are greater than or equal to 30 N/m and less than or equal to 300 N/m.

Each of the spring elements 210A, 210B, 210C, and 210D are attached to the sensor cover 206 at a first end with a first spring attachment point and a mount 208 at a second end with a second spring attachment point. In one example, the first spring attachment point is located adjacent to a perimeter of the sensor cover 206 and the first and second spring attachments include a pivotable connection. The mount 208 is rotatable about an axis A that extends longitudinally through a sensor 204 and sensor lens 216. A drive motor 218, such as a piezo-electric motor, drives the mount 208 through a mechanical connection, such as a gear drive or belt drive, to rotate the sensor cover 206.

During operation of the sensor assembly 200, aerodynamic conditions, such as a flow of air depicted by arrow F, can cause the sensor cover 206 to move or wobble relative to the housing 202. The movement can occur when the aerodynamic forces applied to the sensor cover 206 cause at least one of the spring elements 210 to compress. For example, as shown in FIGS. 3-4, the spring elements 210A and 210B have stiffnesses K1 and K2 that are greater than the stiffnesses K3 and K4. This can cause one of the spring elements 210C and 210D to compress and the other of the spring elements 210C and 210D to expand or lengthen as the sensor cover 206 pivots about the spring elements 210A, 210B. The spring elements 210A and 210B may provide a pivot axis for the sensor cover 206 about the first attachment points for each of the spring elements 210A, 210B. Alternatively, the spring elements 210A and 210B may compress slightly and still provide the axis for the sensor cover 206 to pivot about. This results in the sensor cover 206 from wobbling or moving off axis from the sensor 204.

The tilting and wobbling movement of the sensor cover 206 aids in cleaning an exterior surface 206E of the sensor cover 206 from dust particle or water droplets. The exterior surface 206E is located on an opposite side of the sensor cover 206 from an interior surface 206I. The exterior surface 206E may also be continuous with an exterior surface of the housing 202 when not tilted or wobbling or transverse to a portion of the exterior surface of the housing 202 when tilted or wobbling.

The sensor cover 206 can rotate about the axis A through the drive motor 218 in driving engagement with the mount 208 as shown in FIGS. 2-4. One feature of having the mount 208 driven by the drive motor 218 is that the sensor cover 206 will not become stuck in a single position tilted position relative to the axis A because it can pivot around the axis A. This allows the sensor cover 206 to clean itself from debris, such as dust particles or water droplets. Furthermore, the controller 26 may operate the drive motor 218 that rotates the mount 208 that causes the sensor cover 206 to rotate up to a predetermined speed of the vehicle 20, such as an operating speed of the vehicle 20. The controller 26 is in electrical communication and configured to operate the drive motor 218 in response to a first operating condition. In one example, the first operating condition can include a speed of the vehicle 20 being within a predetermined operating range.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A sensor assembly, comprising:
a sensor;
a sensor cover positioned adjacent to the sensor and within a field of view of the sensor, wherein the sensor cover includes an interior surface facing the sensor and an exterior surface facing away from the sensor;
a plurality of spring elements attached to the sensor cover at a first end and a mount at a second end, wherein at least one of the plurality of spring elements includes a first spring stiffness and another one of the plurality of spring elements includes a second spring stiffness; and
a drive motor in mechanical connection with the mount and configured to rotate the sensor cover relative to the sensor.

2. The sensor assembly of claim 1, wherein the plurality of spring elements is positioned around a perimeter of the sensor cover.

3. The sensor assembly of claim 1, wherein the drive motor is a piezo-electric drive motor.

4. The sensor assembly of claim 1, wherein the plurality of spring elements includes at least one coil spring.

5. The sensor assembly of claim 1, wherein the sensor includes an optical sensor having a lens.

6. The sensor assembly of claim 1, wherein the sensor cover is comprised of a transparent material.

7. The sensor assembly of claim 1, wherein the mount forms a ring.

8. The sensor assembly of claim 1, wherein the plurality of spring elements includes a first pair of spring elements located along a first pair of opposing sides of the sensor cover and a second pair of spring elements having a second located along a second pair of opposing sides of the sensor cover.

9. The sensor assembly of claim 8, wherein the first pair of spring elements each include a first stiffness and the second pair of spring elements each include a second stiffness that is less than the first stiffness.

10. The sensor assembly of claim 8, wherein the first pair of spring elements include a first pair of different spring stiffnesses and the second pair of spring elements includes a second pair of different spring stiffnesses that are each less than the first pair of different spring stiffnesses.

11. The sensor assembly of claim 8, wherein the first pair of spring elements include a spring stiffness of greater than or equal to 3000 N/m and less than or equal to 6000 N/m.

12. The sensor assembly of claim 8, wherein the second pair of spring elements include a spring stiffness of greater than or equal to 30 N/m and less than or equal to 300 N/m.

13. A cleaning assembly for a sensor, comprising:
a sensor housing;
a sensor located within the sensor housing;
a sensor cover positioned adjacent to the sensor and within a field of view of the sensor, wherein the sensor cover includes an interior surface facing the sensor and an exterior surface facing away from the sensor;
a plurality of spring elements attached to the sensor cover at a first end and a mount at a second end, wherein at least one of the plurality of spring elements includes a first spring stiffness and another one of the plurality of spring elements includes a second spring stiffness; and
a drive motor in mechanical connection with the mount and configured to rotate the sensor cover relative to the sensor; and
a controller in electrical communication with the drive motor to operate the drive motor under a first operating condition.

14. The cleaning assembly of claim 13, wherein the first operating condition includes an operating speed within a predetermined operating range.

15. The cleaning assembly of claim 13, wherein the plurality of spring elements includes a first pair of spring elements located along a first pair of opposing sides of the sensor cover and a second pair of spring elements located along a second pair of opposing sides of the sensor cover.

16. The cleaning assembly of claim 15, wherein the first pair of spring elements each include a first stiffness and the second pair of spring elements each include a second stiffness that is less than the first stiffness.

17. The cleaning assembly of claim 15, wherein the first pair of spring elements each include a first pair of different spring stiffnesses and the second pair of spring elements includes a second pair of different spring stiffnesses that are each less than the first pair of different spring stiffnesses.

18. A vehicle comprising:
a passenger compartment;
a plurality of wheels supporting the passenger compartment;
a sensor assembly fixed relative to the passenger compartment, wherein the sensor assembly includes:
a sensor;
a sensor cover positioned adjacent to the sensor and within a field of view of the sensor, wherein the sensor cover includes an interior surface facing the sensor and an exterior surface facing away from the sensor;
a plurality of spring elements attached to the sensor cover at a first end and a mount at a second end, wherein at least one of the plurality of spring elements includes a first spring stiffness and another one of the plurality of spring elements includes a second spring stiffness; and
a drive motor in mechanical connection with the mount and configured to rotate the sensor cover relative to the sensor.

19. The vehicle of claim 18, wherein the plurality of spring elements includes a first pair of spring elements located along a first pair of opposing sides of the sensor cover and a second pair of spring elements located along a second pair of opposing sides of the sensor cover.

20. The vehicle of claim 19, wherein the first pair of spring elements include a first pair of different spring stiffnesses and the second pair of spring elements includes a second pair of different spring stiffnesses that are each less than the first pair of different spring stiffnesses.
